(19) United States
(12) Patent Application Publication
(10) Pub. No.: US 2003/0024884 A1
(43) Pub. Date: Feb. 6, 2003

(54) Method for removing oil, petroleum products and/or chemical, pollutants from liquid and/or gas and/or surface

(76) Inventor: Viktor Ivanovich Petrik, Sankt-Petersburg (RU)

Correspondence Address: KENYON & KENYON, ONE BROADWAY, NEW YORK, NY, 10004, US

(21) Appl. No.: 09/848,047

(22) Filed: May 3, 2001

(30) Foreign Application Priority Data
Apr. 2, 2001 (RU) 2001108456

(51) Int. Cl. C02F 1/28

(52) U.S. Cl. 210/691

(57) ABSTRACT

The invention relates to the field of ecology, in particular to the struggle against pollution of the environment with oil, petroleum products, cyclic and aromatic hydrocarbons, other chemical pollutants, i.e. to purification of a water area, waste waters, industrial machinery, polluted soil and grounds etc., and also to the field of objects used to satisfy the vital requirements of humans and to medicine.

A method for removing chemical pollutants includes preparing a carbonaceous mixture of an expanded graphite and carbonaceous nanocrystals of a graphite-containing feedstock, dispersing it onto the surface and/or into a liquid and/or placing on a surface and/or passing a liquid or gas through a filter, and collecting the carbonaceous mixture saturated with the pollutants. The method is used for collecting oil and petroleum products from the surface of water, for filtering drinking water, is used for removing volatile fractions of petroleum products or gaseous condensate from free basins of storage reservoirs, for neutralizing exhaust gases of internal combustion engines as the base of a matrix of a neutralizer of exhaust gases, for filtering cigarette smoke, for purifying blood plasma, for external use in the case of skin integument diseases characterized by discharges.

The invention makes it possible to enhance the effectiveness of the removal of oil and petroleum products and also to ensure the removal of other chemical pollutants.

### BACKGROUND

The invention relates to the field of ecology, in particular to the struggle against pollution of the environment with oil, petroleum products, cyclic and aromatic hydrocarbons, other chemical pollutants, i.e., to purification of a water area, waste waters, industrial machinery, polluted soil and ground, etc., and also to the field of objects used to satisfy the vital requirements of humans and to medicine.

Known are methods for removing different chemical pollutants from different mediums, for example, methods for purifying water and solid surfaces with the use of a “Primesorb” absorbent (U.S.A.). These are sorption processes with the use of an expensive substance having low absorbing capability.

As a rule, the known methods for removing chemical pollutants serve for the achievement of a concrete narrow object relating to purification of either a liquid or a gas or a solid surface.

For example, a method is known for removing an oil film from the surface of water, the method including a closed system of forming a sorbing material (particles of carbon linked by polyethylene), which is on board a ship, dispersing the sorbing material over the surface of the water and collecting it after sorption of the oil (patent U.S. Pat. No. 37,831,296 class E 02 B 15/04, 1974). Drawbacks of this method are the length of the process of sorbing oil and its low sorbing capability (about 75%), which does not make it possible to have an amount of sorbent on board the ship sufficient to purify large water surfaces. Furthermore, the method is not meant for removing oil and petroleum products from land surfaces.

Also known is the removal of hydrocarbon chemical pollutants from water with the use of a filter on carbon base (“Some Aspects of Technology of Preparing Drinking Water,” edited by Prof. V. F. Olontsev, Perm, AES RF, 1997, pp. 33-38). A drawback of such a method is the insufficient effectiveness of water purification.

The use of activated carbon for making filters for tobacco goods is known (application FR No. 24691 34, class A 24 D 3/16, May 29, 1981). Activated carbon is used as the substance which detains the nitrogen oxide contained in tobacco smoke. In addition to nitrogen oxide, filters with use of activated carbon (for example, Philip Morris combined filters) also detain nicotine, 3,4 benzopyrene, aromatic hydrocarbons. However, the content of the indicated substances in the case of use of activated carbon cannot be reduced to a level providing a sufficient protective effect.

All the known methods are means for removal of a certain type of pollutants from the medium being purified and do not have a wide spectrum of action, which limits the possibility of their use and does not ensure that the medium is purified of chemical pollutants to a sufficient degree.

A method for removing chemical pollutants is known, in particular, by collecting spilled oil and petroleum products, including preparing a carbonaceous mixture of high reaction capability (CMHR), placing the CMHR in a polluted medium by dispersing the CMHR over the surface and/or into the body of the water contaminated by spilled oil or petroleum products, and collecting the CMHR after saturation with (addition to) the oil or petroleum products (patent RU No. 2123086, class E 02 B 15/04, Dec. 10, 1998). In this method the CMHR is prepared from natural graphite processed with acid, by resistance heating. Preparation of the CMHR may be carried out on the ship—collector of the oil.

This method is substantially more effective, but the power consumption is relatively high and the presence of complex equipment for production of the CMHR is required.

Furthermore, the effectiveness of the removal is not high enough to provide the possibility for removal of a wide spectrum of chemical pollutants from the contaminated medium. Furthermore, as a rule, sorbents are for one-shot use.

### SUMMARY OF THE INVENTION

The present invention provides a method for removing chemical pollutants comprising the steps of preparing a carbonaceous mixture of a graphite-containing feedstock; placing the carbonaceous mixture in a contaminated medium; and collecting the carbonaceous mixture saturated with pollutants.

### DETAILED DESCRIPTION OF THE INVENTION

The present invention provides enhancing the effectiveness of the removal of oil and petroleum products, and also provides for the removal of other chemical pollutants as a result of the presence of a mixture of carbon nanocrystals (carbonaceous nanotubes) in the composition, which have a high absorbing capability in respect to different chemical substances and compounds, in an amount sufficient for the effective removal of pollutants. Furthermore, the possibility for repeated use of the carbonaceous mixture is provided.

The stated object is provided for in a method for removing chemical pollutants, comprising preparing a carbonaceous mixture of a graphite-containing feedstock, placing the carbonaceous mixture in a contaminated medium and collecting the carbonaceous mixture saturated with pollutants. Placing the carbonaceous mixture in the contaminated medium is carried out by dispersing onto a surface and/or a liquid and/or by placing on a surface and/or by passing a liquid or a gas through a filter, and a mixture of expanded graphite and carbonaceous nanocrystals is used as the carbonaceous mixture, wherein the content of the carbonaceous nanocrystals in the mixture is not less than 10%.

Wherein the nanocrystals are nanotubes having a size of 1-10 nm, with added thereto free C, C₂, C₃, C₄, C₅ radicals, and/or radicals in the form of one or several connected hexagonals and/or hexagonals with added thereto radicals of the type C, C₂, C₃, C₄, C₅.

The preparation of the carbonaceous mixture is carried out by chemical processing of the graphite-containing feedstock with at least one halogen-oxygen compound having the formula MXOfₙ, where M is one of the chemical substances selected from the group: H, NH₄, Na and K; X is one of the chemical substances selected from the group Cl, Br, and I; and n is 1,2,3, or 4, and subsequent external action resulting in exothermal explosive-like decomposition of the processed graphite-containing stock with subsequent initiation of an autocatalytic breakdown process, wherein application of the action is carried out at normal pressure and room temperature.

Wherein the external action is carried out by photochemical or electrochemical or mechanical or thermochemical or sonochemical or direct chemical action.

Either natural flaked graphite or graphite in the form of powder is used as the graphite-containing feedstock.

In order to provide the optimum mode of preparation of the carbonaceous mixture, the weight ratio of the graphite-containing feedstock to the halogen-oxygen compound is about to 2:1.

When the collection of the spilled oil, petroleum products and other hydrocarbon pollutants is from the surface of water, the carbonaceous mixture may be prepared on the ship collecting the oil or oil shore.

After collecting the carbonaceous mixture of expanded graphite and carbonaceous nanocrystals, which is saturated with chemical pollutants, the collected hydrocarbon pollutants may be removed from the carbonaceous mixture by the compression method (with the use of a press).

The carbonaceous mixture of expanded graphite and carbonaceous nanocrystals may be used again.

In particular, the method of removing chemical pollutants is used for the collection of oil and petroleum products from the surface of water, wherein preparation of the carbonaceous mixture of expanded graphite and carbonaceous nanocrystals is carried out on the ship-collector of the oil or oil shore, and the placing of the carbonaceous mixture of expanded graphite and carbonaceous nanocrystals on the surface of water is carried out by dispersal into the body of the water and/or onto the surface of the water and/or by the placement of floating barriers on the surface of the water.

The method for removing chemical pollutants is also used for filtration of drinking water comprising chemical pollutants, including hydrocarbon compounds, with the use of a filter made of a carbonaceous mixture of expanded graphite and carbonaceous nanocrystals.

Furthermore, the method for removing chemical pollutants is used to purify industrial discharges.

Furthermore, the method for removing chemical pollutants is used for the removal of light fractions of petroleum products or gaseous condensate from free spaces of storage reservoirs.

Furthermore, the method for removing chemical pollutants is used for neutralization of exhaust gases of internal combustion engines as the base of a matrix of a neutralizer of exhaust gases.

Furthermore, the method for removing chemical pollutants is used as a filter for cigarettes for filtration of cigarette smoke.

In the field of medicine the method for removing chemical pollutants is used for purification of blood plasma.

The method for removing chemical pollutants is also used in the field of medicine for external application in cases of skin integument diseases which are characterized by discharge, in particular in the case of burns and purulent wounds, wherein placement on the skin integument is accomplished by the application of a bandage with a carbonaceous mixture.

The method for removing chemical pollutants is based on preparing a carbonaceous mixture having a huge reactive and sorption capability in respect to any hydrocarbon compounds, other chemical compounds, metal ions. Such properties of the carbonaceous mixture are due to the presence of nanocrystals of carbon in the form of nanotubes having a size of 1 -10 nm and a large degree of disorder, and to the fact that during the preparation of a mixture of natural flaked graphite or graphite in the form of powder or another graphite containing raw material, not only stratification of crystallites into separate packets of basal planes, as in known methods of preparing expanded graphite, but also breakage of inter-hexagonal covalent links take place. This results in the formation of energetically stressed atomic compounds of carbon. Furthermore, the prepared carbonaceous mixture is a hydrophobic material, i.e. it does not absorb water and does not combine with water (marginal wcuing angle greater than 90″).

During the preparation of a carbonaceous mixture, chemical processing of the graphite-containing feedstock (natural flaked graphic or graphite in the form of powder) is carried out with halogen-oxygen compounds of the general formula MXOₙ, wherein: M is one of the chemical substances selected from the group Cl, Br, and I: and n is 1, 2, 3,or 4, with the formation of initiating complexes, capable as a result of photochemical, mechanical, thermochemical, sonochemical or direct chemical action, of exothermal explosive-like decomposition with the subsequent initiation of an autocatalytic process of decomposition of the compound. Initiating complexes are introduced into the interlayer space of graphite, their explosive-like decomposition is initiated and there is not only a break of van der Waals links but also of covalent links, which results in the formation of a carbonaceous mixture. When the process is carried out under conditions close to normal atmospheric pressure (760 mm Hg) and room temperature (20° C.), the formation of carbon nanotubes takes place in a relationship sufficient for the effective removal of chemical pollutants (not less than 10%).

The process of conversion of graphite (the break of van der Waals links) is carried out under the action of micro-explosions of explosive substances introduced into the interlayer spaces of the graphite, in this case the aforesaid initiating complexes. The explosive substance is in the interlayer space at a molecular level and is initiated in a chemical way to an explosion. As a result of the energy freed by the micro-explosion, not only a break of van der Waals links occurs, but there is also a break of interatomic links with the formation of not only nanotubes, but also free radicals C, C₂, C₃, C₄, C₅ and radicals in the form of hexagonals (one or several) with added thereto radicals of the type C, C₂, C₃, C₄, and C₅ which ensure in combination a high reaction capability of the obtained carbonaceous mixture.

The carbonaceous mixture is a substance in the form, of fluff and/or dust with a 99.4% weight content of carbon, with a bulk density of from 0.002 g/cm³ to 0.01 g/cm³, pore size to 40 um.

The micro-structure of the carbonaceous mixture is formed by granules which have a stretched fiber structure (similar to a shredded bast) on its surface with a diameter of the fibers being about single-digit micrometers and even fractions thereof.

The process of conversion is carried out in any container (vessel, etc.), including the possible case without access of oxygen.

The installation for the production of the carbonaceous mixture is compact and does not contain a lot of metal. As a result, a specific feature of the method for removing chemical pollutants is the possibility of preparing the carbonaceous mixture not only under industrial conditions, but also directly at the place of use of preliminary prepared feedstock.

Preparation of the feedstock for preparing the carbonaceous mixture is carried out in a centralized manner at the place where it is stored and does not require special conditions, energy and labor expenditures. There it may be conveyed without packaging (like, for example, ordinary earth) or in containers, in the necessary amounts together with generating devices the places of their use or storage (sea, air or ground emergency [life-saving] or liquidation bases, concrete objects). Wherein the carbonaceous mixture in a self-generation modification may be packaged in individual cases (of the fire extinguisher type), may be formed into briquettes and granules, which have the necessary weight characteristics for their remote application onto the objects to be acted on.

Application of the carbonaceous mixture onto the places of collection of oil and petroleum products and onto other objects may be carried out by spraying from the air, from the surface or from under the surface of water, or by preliminarily applying the material onto the place of a possible spill.

The physical, chemical and technological properties of the carbonaceous mixture make it possible to rapidly and effectively adapt it to concrete conditions of use and to machinery and technologies existing for these purposes (aviation, sea, automobile transport, etc.), or to universalize it.

The bulk density of the carbonaceous mixture is substantially less than the bulk density of the feedstock. Furthermore, the absorbing capability of the carbonaceous mixture in respect to crude oil is not less than 1 to 50, i.e. one gram of the carbonaceous mixture adds thereto at least 50 grams of hydrocarbon compounds. Thus, the possibility is provided for processing huge contaminated surfaces of the sea for one voyage of the ship, without having to reload it. Wherein the carbonaceous mixture reliably holds the collected petroleum products, hydrocarbon compounds and other chemical pollutants, remaining sufficiently dry, which makes it possible to use the least expensive dry-cargo craft for collection of oil and petroleum products.

The function and advantage of these and other embodiments of the present invention will be more fully understood from the examples below. The following examples are intended to illustrate the benefits of the present invention, but do not exemplify the full scope of the invention.

### EXAMPLES

### Example 1

When the method for removing oil and petroleum products is being carried out, the discharge of the carbonaceous mixture may be accomplished directly into the body of the water under the contaminated surface or directly onto the surface, and due to the small specific weight it easily rises to and is held on the surface, absorbing therein or adding thereto hydrocarbon pollutants, for example, oil.

A possible device for feeding the carbonaceous mixture into the mass of water is a device consisting of racks with sprayer heads for supplying a water-air-powder composition into the water, a unit for mixing gas (air) with powder (fluildized powders) and feeding it into the mixing unit with pressure (line) water. A screw centrifugal pump may be used as the source of pressure (line) water. A compressor (blower) is used as the source of air with the pressure necessary for fluidizing the powder.

When the finely dispersed powder (carbonaceous mixture) is fed to a depth of 0.8-1.0 meter front a carrier moving at a rate of 2 meters per second, 15 grams of powder add to 1.5 kg of oil, wherein the powder relatively rapidly and uniformly mixes with the water and during the period of settling tends to intensively rise. After about one minute has passed, 98% of the powder rises to the surface of the water.

The carbonaceous mixture added to the hydrocarbon pollutants, for example, to oil, may be easily collected from the surface of the water by known methods.

The carbonaceous mixture is also easily removed together with oil and other hydrocarbon pollutants from the surface of land with use of cleaning (gathering) machines or after preliminarily washing off the saturated carbonaceous mixture with water into an open canal or any other body of water with subsequent collection like collection from the surface of water.

The oil or other hydrocarbon pollutants thus collected remain suitable for further use in accordance with their direct purpose, and the pressed out carbonaceous mixture is suitable for repeated use, which is very important in the case of natural calamities and ecological catastrophes related to the spilling of oil, petroleum products, other harmful hydrocarbon compounds, especially when they fall into water.

In order to prevent the further propagation of all oil spot on a water surface, a floating barrier may be used, this barrier being a cloth cylinder with a “filling” of the carbonaceous mixture. The floating barrier eliminates the flow of the iridescent (oil) film downstream, wherein accumulation of a film of petroleum products before the floating barrier will not occur, which confirms the process of the petroleum products being absorbed by the carbonaceous mixture, as exemplified by purification of the water of small Moscow rivers (Table 1).

### Example 2

The method for removing chemical pollutants used for purification of industrial discharges has shown very good results in respect to the removal of both anions and cations.

Tests which were carried out and the results of chemical analysis have shown that the carbonaceous mixture has excellent properties in respect to a significant number of organic and inorganic chemical compounds. For example, it absorbs (with a relatively small thickness of the filters, about 10 cm) petroleum products and other soluble substances from solutions to levels lower than prescribed maximum permissible concentrations (the degree of purification is more than 1000 times). The carbonaceous mixture has also shown high effectiveness for the removal of many cations, including copper (by 30 times), chromium (+6) (by 5 times), iron (by 3 times), ammonium (by 2-3 times), vanadium (by 5 times), manganese (by 2 times), phosphates (by 35 times), fluorides (by 5 times), initiates (by 3 times). Furthermore, the carbonaceous mixture works as a sedimentation filter—the concentration of suspended particles decreases by more than 100 times.

Data on the content of chemical pollutants prior to purification and after one purification with the indicated method are shown in Table 2.

### Example 3

The method for removing chemical pollutants may be used for purification of drinking tap, well and artesian well water.

A filter with an 8 cm thickness of the filtering layer of the carbonaceous mixture was used for purifying drinking water. Wherein high effectiveness was achieved in the majority of the most important rated indices. In particular, a high degree of removal of sulfates, sulfides, fluorides, chlorides, nitrates, ammonium nitrogen, iron, zinc, copper, aluminum, manganese, lead, molybdenum, free chlorine was achieved. Reduction of turbidity by 25-60 times, reduction of the amount of suspended particles by 10-30 times are observed.

Comparative data on the state of the water after purification with the aid of a “Barner” filter and with the aid of the carbonaceous mixture are presented in Table 3, and comparative data on the purification of drinking water taken from different sources are presented in Table 4.

### Example 4

Tests of the method in vitro were carried out in the Laboratory of Hermodialysis and Plasmaphoresis of the Russian Cardiological Scientific-and-Industrial Complex of the Ministry of Health of the Russian Federation. The tests were carried out with use of a roller pump of the “Gambro” firm and a slot type nozzle. Patients' blood was preliminarily divided oil a plasma separator PF-0.5, i.e. the plasma exchange procedure was carried out. The separated plasma was then passed through the carbonaceous mixture.

Among the 13 analyzed parameters, significant changes were observed in respect to reduction of the level of uric acid (the level of reduction exceeded 50%) and a tendency towards reduction of the level of creatine (a metabolite of nitrogenous exchange) was noted.

### Example 5

Clinical tests of use of the method for local treatment of wounds have shown the following:

Since the carbonaceous mixture is a powder watch easily penetrates through a layer of medical gauze, in order to prevent the powder falling on a granulating wound, sticking of the powder and its impregnation into the wound, the following bandages were used, which comprise a layer of synthetic non-woven temporary Derma-safe wound coating, which is formed by thin, porous sterile napkins with a composition of: viscose—66%, polyester 34%, or two-three layers of medical gauze and 1-2 layers of porous paper.

The bandages are envelopes of rectangular shape having dimensions 6×8 or 5×6 cm, inside which is the carbonaceous mixture. In order to check the effectiveness of the bandages being, tested in respect to their affect on the bacterial dissemination of wounds, inoculations were carried out to determine the number of microbe bodies on the surface of the wound before and after use of the sorbing bandages. The tests showed a significant reduction of the pus secreted from the wound after use of the sorbing bandages.

TABLE 1

| | | | | Result of CCA | |
|---|---|---|---|---|---|
| Date of | Place where | Components | | mg/l | |
| carrying out | analysis was | being | Method of | before | after |
| analysis | carried out | determined | analysis | barrier | barrier |
| 09.12.99 | Waste waters | Floating petroleum | IR | 0.12 | 0.010 |
| | (Marinsky Park) | products | | | |
| 09.12.99 | Nischenka | Floating petroleum | IR | 0.34 | 0.035 |
| | River | products | | | |
| 09.12.99 | Chura River | Floating petroleum | IR | 0.4 | 0.041 |
| | | products | | | |
| 09.12.99 | Tarakanovka | Floating petroleum | IR | 0.78 | 0.050 |
| | River | products | | | |
| 11.01.00 | Chura River | Floating petroleum | IR | 2.7 | 0.18 |
| | | products | | | |
| 11.01.00 | Waste waters | Floating petroleum | IR | 5.4 | 0.96 |
| | (Butovo) | products | | | |
| 25.02.00 | Waste waters | Phenols | chromat. | 0.11 | <0.01 |
| | OAO “Neftpro- | Petroleum products | IR | 86.6 | 0.05 |
| | dukty” | Benzopyrene | chromat. | 0.8 | <0.005 |
| | | Hydroquinone | chromat. | 2.5 | 0.5 |
| | | Phenolcarboxylic | | | |
| | | acid | chromat. | 63 | 11 |

TABLE 2

| | | Weight fraction | |
|---|---|---|---|
| | | of component | |
| | | in samples, (mg/l) | |
| | | Before | After 1st |
| No. | Name of compound | purification | purification |
| 1 | Caproic acid | 351 | 191 |
| 2 | Tetrahydrothiophen | 2.1 | 1.7 |
| 3 | Isothiazole | 10.9 | 5.0 |
| 4 | 2,3-Dimethyl-1,4-hexadiene | 0.8 | 0.2 |
| 5 | Isovaleric acid | 5.1 | 1.4 |
| 6 | Valeric acid | 74.9 | 39.6 |
| 7 | Enanthic acid | 112 | 82 |
| 8 | Caprylic acid + Benzoic acid | Σ55.5 | Σ43.8 |
| 9 | 2-Ethylenehexanoic acid | 5.2 | 0 |
| 10 | β-Propylacrylic acid | 2.9 | 0 |
| 11 | Phenylacetic acid | 16.3 | 9.6 |
| 12 | Phenobarbital metabolite | 3.2 | 0 |
| 13 | 1-Methyl phenyl cyclopropane | 3.0 | 0 |
| 14 | Cyclohexanacetic acid | 3.2 | 2.6 |
| 15 | Terephthalic anhydride | 20.6 | 6.8 |
| 16 | Phenol | 49.3 | 14.1 |
| 17 | Hydrocinnamic acid | 14.1 | 0.3 |
| 18 | Caprylic acid | 9.2 | 7.8 |
| 19 | 2,3-Dimethylquinoxaline | 5.3 | 1.5 |
| 20 | N,N-Dimethylformamide | 42.6 | 14.9 |
| 21 | Cyclopropyl benzene | 3.8 | 0.4 |
| 22 | α-Phenylbenzyl alcohol | 3.8 | 0 |
| 23 | Cyclohexanol | 294 | 203 |
| 24 | Bi | 0.043 | 0.028 |
| 25 | Ni | 0.96 | 0.36 |
| 26 | Al | 0.61 | 0.38 |
| 27 | Na | 450 | 380 |
| 28 | Cr | 2.4 | 0.55 |
| 29 | Ca | 42.4 | 33.0 |
| 30 | Co | 0.052 | 0.012 |
| 31 | Re | 2.4 | 0.46 |
| 32 | Hg | 0.00066 | 0.00042 |
| 33 | Phosphate-ion | 25.0 | 5.8 |
| 34 | Nitrate-ion | 0.11 | <0.1 |
| 35 | As | 0.018 | 0.012 |
| 36 | Sb | 0.01 | <0.005 |

TABLE 3

| | | Result of analysis (CCA), | |
|---|---|---|---|
| | Initial water | mg/l | |
| Components being | (Ramenskoe city | After filter | After filter of |
| determined | water supply line) | “Barrier” (U.S.A.) | carbonaceous mixture |
| Chromaticity, degree | 28 | 23 | 4 |
| Suspended substances | 79 | 22 | 3 |
| Turbidity, EMF | 117 | 32 | 2 |
| Iron, general | 8.75 | 1.87 | 0.01 |
| Ammonium nitrogen | 0.52 | 0.18 | 0 |
| Sulfides | 0.008 | 0.004 | 0.002 |
| Fluorides | 1.03 | 0.95 | 0.87 |
| Phosphates | 0.14 | 0.12 | 0.08 |

What is claimed is:

1. A method for removing chemical pollutants comprising the steps of:
a. preparing a carbonaceous mixture of a graphite-containing feedstock;
b. placing the carbonaceous mixture in a contaminated medium containing chemical pollutants; and,
c. collecting the carbonaceous mixture saturated with chemical pollutants.

2. The method of claim 1, wherein the step of placing the carbonaceous mixture in the contaminated medium is carried out by dispersing the carbonaceous mixture onto a surface.

3. The method of claim 1, wherein the step of placing the carbonaceous mixture in the contaminated medium is carried out by dispersing the carbonaceous mixture into a liquid.

4. The method of claim 1, wherein the step of placing the carbonaceous mixture in the contaminated medium is carried out by passing a liquid or a gas through a filter.

5. The method of claim 4, wherein the filter comprises a mixture of expanded graphite and carbonaceous nanocrystals, wherein the content of the carbonaceous nanocrystals in the mixture is not less than 10%.

6. The method of claim 5, wherein the carbonaceous nanocrystals are nanotubes having a size of 1-10 nm, with added thereto free C, C₂, C₃, C₄, C₅ radicals.

7. The method of claim 6, wherein the radicals are in the form of one or several connected hexagonals.

8. The method of claim 7, wherein the radicals are in the form of one or several connected hexagonals with added thereto radicals of the type C, C₂, C₃, C₄, and C₅.

9. The method of claim 1, wherein preparing the carbonaceous mixture is carried out by chemical processing of the graphite-containing feedstock with at least one halogen-oxygen compound having the formula MXOₙ, wherein:
a. M is selected from the group of chemical substances consisting of H, NH₄, Na and K;
b. X is selected from the group of chemical substances consisting of Cl, Br, and I; and,
c. n is 1,2,3,or 4.

10. The method of claim 9, further comprising a subsequent external action which results in exothermal explosive-like decomposition of the processed graphite-containing stock with subsequent initiation of an autocatalytic breakdown process.

11. The method of claim 10, wherein the subsequent external action is carried out at normal pressure and room temperature.

12. The method of claim 10, wherein the subsequent external action is carried out by a process selected from the group consisting of photochemical, electrochemical, mechanical, thermochemical, sonochemical and direct chemical processes.

13. The method of claim 9, wherein the weight ratio of the graphite-containing feedstock to the halogen-oxygen compound is about 2:1.

14. The method of claim 1, wherein the graphite-containing feedstock is natural flaked graphite or graphite in the form of powder.

15. The method of claim 1, further comprising a step of removing chemical pollutants from the carbonaceous mixture saturated with chemical pollutants.

16. The method of claim 15, wherein the chemical pollutants are hydrocarbon pollutants.

17. The method of claim 15, wherein the step of removing chemical pollutants from the carbonaceous mixture is performed by a compression method.

18. The method of claim 17, wherein the compression method is accomplished by squeezing with a press.

19. The method of claim 15, further comprising reusing the carbonaceous mixture of expanded graphite and carbonaceous nanocrystals following removal of the chemical pollutants.

20. The method of claim 1, wherein removing the chemical pollutants is characterized by collecting oil and petroleum products from the surface of water.

21. The method of claim 20, wherein the placing of the carbonaceous mixture of expanded graphite and carbonaceous nanocrystals on the surface of water is carried out by dispersal into the body of the water.

22. The method of claim 21, further comprising placing a floating barrier on the surface of the water.

23. The method of claim 1, wherein the method is used for filtering drinking water comprising chemical pollutants using a filter made of a carbonaceous mixture of expanded graphite and carbonaceous nanocrystals.

24. The method of claim 23, wherein the chemical pollutants include hydrocarbon compounds.

25. The method of claim 1, wherein the method is used for removing chemical pollutants from industrial discharges.

26. The method of claim 1, wherein the method is used for purifying chemical pollutants from industrial discharges.

27. The method of claim 1, wherein the method is used for the removal of light fractions of petroleum products or gaseous condensate from free spaces of storage reservoirs.

28. The method of claim 1, wherein the method is used for neutralization of exhaust gases of internal combustion engines as the base of a matrix of a neutralizer of exhaust gases.

29. The method of claim 1, wherein the method is used as a filter for cigarettes for filtration of cigarette smoke.

30. The method of claim 1, wherein the method is used for purification of blood plasmas.

31. The method of claim 1, wherein the method is used as a sorbent for external application in cases of skin integument diseases which are characterized by discharge.

32. The method of claim 31, wherein placement on the skin integument is accomplished by the application of a bandage with a carbonaceous mixture.

33. The method of claim 31, wherein the method is used for treatment of burns and purulent wounds.
